(19) United States
(12) Patent Application Publication
(10) Pub. No.: US 2025/0213896 A1
(43) Pub. Date: Jul. 3, 2025

(54) Systems and Methods for Reserving a Portion of a Lifeline for Fall Arrest

(71) Applicant: Latchways Plc, Dorset (GB)

(72) Inventor: Oliver HENSBERG, Devizes (GB)

(21) Appl. No.: 18/998,342

(22) PCT Filed: Jul. 26, 2023
(86) PCT No.: PCT/EP2023/070783

§ 371 Date: Jan. 24, 2025

(30) Foreign Application Priority Data
Jul. 28, 2022 (GB) 2211120.7

(51) Int. Cl. A62B 35/00; A62B 35/04

(52) U.S. Cl. CPC A62B 35/0093; A62B 35/04

(57) ABSTRACT

Systems and methods are provided for a fall limiting device. A device includes a housing having a lifeline therein. A fall arrest mechanism is configured to apply a braking force to the lifeline based on motion of the lifeline. A reserve retainer is attached to the lifeline, the reserve retainer being configured to retain a portion of the lifeline in the housing during a first operating condition. The fall limiting device is configured to allow the retained portion of the lifeline to extend from the housing during a second operating condition, where the fall arrest mechanism is configured to apply the braking force to the lifeline during the second operating condition.

### BACKGROUND

In height safety applications, such as, for example, working on a building roof, it is common for a fall limiting device, such as a self-retracting lanyard (SRL), to be provided for connection to a structure or a safety line. In normal operation, the fall limiting device allows a lifeline to be output from the fall limiting device to allow the user some freedom of movement. In the event of a fall, the fall limiting device may include mechanisms for arresting the fall while maintaining the integrity of the fall limiting device and lifeline so as to avoid or limit injury.

### SUMMARY

Systems and methods are provided for a fall limiting device. A device includes a housing having a lifeline therein. A fall arrest mechanism is configured to apply a braking force to the lifeline based on motion of the lifeline. A reserve retainer is attached to the lifeline, the reserve retainer being configured to retain a portion of the lifeline in the housing during a first operating condition. The fall limiting device is configured to allow the retained portion of the lifeline to extend from the housing during a second operating condition, where the fall arrest mechanism is configured to apply the braking force to the lifeline during the second operating condition.

In another example, a method of arresting a fall of a user includes providing a housing having a lifeline therein, where the housing is connected to a structure and the lifeline is connected to the user. A portion of the lifeline is paid out from the housing while retaining a retained portion of the lifeline in the housing during a normal operating condition, where the retained portion is retained within the housing by a reserve retainer attached to a point on the lifeline. The retained portion is paid out from the housing during a fall operating condition, and an arrest mechanism is activated to apply a braking force to the lifeline based on paying out the retained portion.

In a further example, a fall limiting device includes a housing having a lifeline therein, a fall arrest mechanism configured to apply a braking force to the lifeline based on motion of the lifeline, a reserve retainer attached to the lifeline; and a lifeline stop connected to the housing that is configured to interact with the reserve retainer to retain a portion of the lifeline in the housing during a normal operating condition. The lifeline stop is configured to be breached or disconnected from the housing based on a force greater than a threshold force being applied to the lifeline stop by the reserve retainer.

### BRIEF DESCRIPTION OF DRAWINGS

FIG. 1 is a diagram depicting a safety line system securing a person performing construction operations at the top of a structure.

FIG. 2 is a diagram depicting a fall limiting device operating in a first, normal operating condition.

FIG. 3 is a diagram depicting a fall limiting device during a second, fall operating condition.

FIG. 4 is a diagram illustrating an unwinding-speed limit control in stowed position attached to a rotatable drum.

FIG. 5 is a diagram depicting a fall limiting device that utilizes a reserve retainer.

FIG. 6 is an internal view of a fall limiting device.

FIG. 7 provides another internal view of a fall limiting device.

FIG. 8 provides an exterior view of a fall limiting device in a normal operating condition.

FIG. 9 provides an exterior view of a fall limiting device after experiencing a second, fall operating condition.

FIG. 10 provides another exterior view of a fall limiting device after experiencing a second, fall operating condition.

FIG. 11 depicts components of a lifeline stop assembly.

FIG. 12 is a diagram depicting example components of a reserve retainer.

FIG. 13 depicts a braided lifeline having a lifeline insert inserted between strands of the lifeline.

FIG. 14 depicts a reserve retainer installed on a lifeline, where a shrink wrap material has been installed to cover both the reserve retainer and a portion of the lifeline.

FIG. 15 depicts example steps of attaching a reserve retainer to a lifeline.

FIG. 16 is a flow diagram depicting a method of arresting a fall of a user includes providing a housing having a lifeline therein

### DETAILED DESCRIPTION

System and methods as described herein provide techniques for allowing a fall limiting device to output (pay out) a portion of the lifeline associated with the fall limiting device from its housing during normal operation to allow a connected user some freedom of movement while retaining a portion of the lifeline within the housing. In embodiments, the fall limiting device utilizes a fall arrest mechanism that is activated based on motion of the lifeline. Were the fall limiting device to allow the entirety of the lifeline to be paid out, that fall arrest mechanism would not be able to be activated. By retaining a portion of the lifeline within the housing during normal operations, but allowing that retained portion of the lifeline to be paid out or extended during a fall condition, the fall arrest mechanism can be properly activated such that injury to the user is avoided or mitigated.

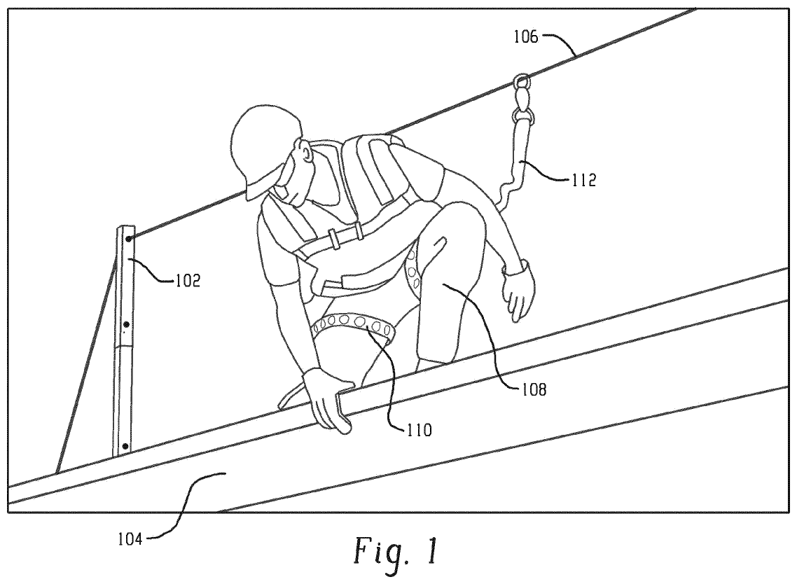

FIG. 1 is a diagram depicting a safety line system securing a person performing construction operations at the top of a structure. The system includes a first rigid member 102 that takes the form of a vertical post extending from a horizontal component 104 of the structure. The first rigid member 102 may be connected to the horizontal component 104 via mechanical means such as bolts, screws, adhesive, or otherwise. A safety line 106 is connected to the first rigid member 102 and runs horizontally between the first rigid member 102 and a second rigid member (not shown). An operative 108, in the form of a user person performing construction operations, wears a harness 110 via which the user 108 is connected to the safety line 106 via a tether 112. The safety line arrangement of FIG. 1 enables the user 108 to traverse the structure, anywhere within a tether length of the safety line. The tether 112 is connected to a fall limiting device (not shown) which is further connected to the harness 110 of the user 108. In accordance with embodiments herein, the fall limiting device is configured to pay some of the lifeline during normal operation to allow the user 108 some freedom of movement, while a reserve retainer attached to the lifeline retains a portion of the lifeline in the housing during that first normal operation condition.

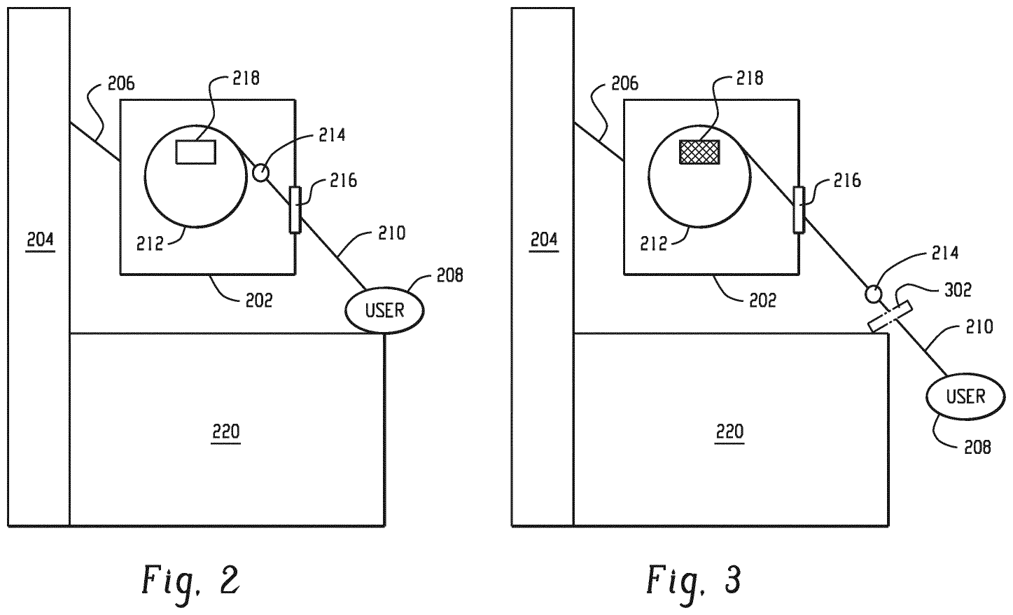

FIG. 2 is a diagram depicting a fall limiting device (not to scale) operating in a first, normal operating condition. A fall limiting device 202 is connected to a first structure 204 via connection 206. That connection 206 may take a variety of forms including a line from the fall limiting device 202 to the first structure 204 connected directly or indirectly using a connection device(s), such as hooks, clips, loops, carabiners. The connection 206 may also be direct using connection devices, such as a carabiner connected to the fall limiting device 202 being clipped to a loop or hook attached to the first structure 204. The first structure 204 may take a variety of forms including a wall, a line (e.g., as depicted in FIG. 1), a horizontal (e.g., floor) structure, and a sloping roof. A user 208 is also connected to the fall limiting device 202 via a lifeline 210 having a portion of its length wrapped around a lifeline drum 212 inside a housing of the fall limiting device 202. In an example, the user 208 is connected to the lifeline 210 of the fall limiting device 202 via a connection device such as a hook, clip, loop, or carabiner when working on horizontal second structure 220 in the vicinity of where the fall limiting device 202 is connected to the first structure 204 via 206. In embodiments, the user 208 may clip out of and into lifelines of different fall limiting devices as the user 208 moves around a work site. The lifeline 210 may take a variety of forms including a single metal line, a braided metal line, a single synthetic material line, a synthetic material line made from multiple strands, a natural material line made of strands.

In a first, normal operation, such as when the user 208 is safely working on second structure 220, the fall limiting device 202 allows a portion of the lifeline 210 to be paid out from the housing of the fall limiting device 202 to provide the user 208 some freedom of movement. In a fall limiting device 202 that takes the form of a self-retracting lanyard, the lifeline drum 212 may be biased by a spring or other mechanism that reels in the paid out lifeline 210 when not under tension by the current location of the user 208. A reserve retainer 214 may be attached to the lifeline (e.g., at a specific point on the lifeline 210) so as to limit an amount of the lifeline 210 that may be paid out. In an embodiment, when the point on the lifeline 210 having the reserve retainer 214 reaches the threshold of the fall limiting device 202 at a lifeline stop 216 (e.g., a slot that is wide enough for the lifeline 210 to pass through but not the wider reserve retainer 214), the interaction of the reserve retainer 214 and the lifeline stop 216 prevents further output of the lifeline 210 from the fall limiting device 202 during the first, normal operating condition.

The fall limiting device 202 further includes a fall arrest mechanism 218, which in FIG. 2 is in the disengaged state. The fall arrest mechanism 218 acts alone or in combination with other fall arrest mechanisms (e.g., inline energy absorbers connected between the lifeline 210 and the user 208, between the fall limiting device 202 and the first structure 204) to halt and mitigate damage from a user fall. In embodiments, the fall arrest mechanism 218 is deployed based on motion (e.g., acceleration, centripetal force initiated by fast payout) of the lifeline 210. In certain examples, the fall arrest mechanism 218 is attached to the lifeline drum 212 and is deployed based on forces experienced when the lifeline drum 212 rotates at more than a threshold rate. For example, and as described further herein, the fall arrest mechanism 218 may include one or more pawls that rotate from a stowed position to an engaged position based on centripetal force provided by rotation of the lifeline drum 212 when the lifeline 210 is paid out at a high rate of speed, such as during a fall condition. It is desirable for this deployment to occur regardless of whether the lifeline 210 is only slightly paid out, paid out close to where the reserve retainer 214 interacts with the lifeline stop 216, and where the lifeline 210 is paid out to the point where the reserve retainer 214 interacts with the lifeline stop 216. In instances where the lifeline 210 is fully paid out (i.e., beyond the point where the reserve retainer 214 would interact with the lifeline stop 216) prior to a fall condition, that lifeline drum 212 rotation would not occur, such that the fall arrest mechanism 218 may not properly deploy. The retention of a portion of the lifeline 210 via interaction of the reserve retainer 214 and the lifeline stop 216 during the first, normal operating condition ensures that a sufficient amount of lifeline 210 (e.g., one half of a meter, one meter) is retained within the housing to induce sufficient rotation of the lifeline drum 212 to engage the fall arrest mechanism 218 during a fall event.

FIG. 3 is a diagram depicting a fall limiting device 202 during a second, fall operating condition. In the example of FIG. 3, the user 208 remains connected, via lifeline 210 to the fall limiting device 202, which is further connected to first structure 204 via connection 206. In the example of FIG. 3, the user 208 has fallen from horizontal structure 220, which transitions the fall limiting device 202 from a normal, first operating condition, to a second, fall condition (e.g., a fall condition, an abnormal condition, an alarm condition, an alert condition, an emergency condition). As illustrated in FIG. 3, in the second, fall condition, the portion of the lifeline 210 holding the reserve retainer 214 (i.e., the portion of the lifeline 210 retained in the housing during the first, normal operating condition) has been extended to the outside of the housing of the fall limiting device 202.

As described further herein, this extension of the retained portion of the lifeline 210 from the fall limiting device (e.g., the portion of the lifeline behind the reserve retainer 214) may occur in a variety of ways. For example, as illustrated by the solid depiction of the lifeline stop 216, the reserve retainer 214 may traverse (e.g., breach) the lifeline stop 216 in the second, fall operating condition. In one example, the reserve retainer 214 may be made of a pliable material (e.g., rubber) that cannot traverse the lifeline stop 216 based on forces experienced during the first, normal operating conditions. But, during the second, fall condition, a sufficient force may be applied to the reserve retainer 214 and lifeline stop 216 by the lifeline 210 connected to the falling user 208, such that the reserve retainer 214 is deformed and squeezes through the lifeline stop 216 allowing the retained portion of the lifeline 210 to be paid out. In another example, the reserve retainer 214 may be formed of a fractureable material. When subjected to forces above a threshold level during the second, fall condition, the reserve retainer 214 may be configured to break (e.g., without breaking the lifeline 210), such that the point on the lifeline 210 where the reserve retainer 214 is (was) attached can traverse the lifeline stop 216, allowing the retained portion of the lifeline 210 to be paid out. In a further embodiment, the lifeline stop 216 may be configured to fracture (e.g., when made of a fracturable material) or deform (e.g., when made of a pliable material) to allow the reserve retainer 214 to breach the lifeline stop 216 and/or the fall limiting device 202 housing.

In another example indicated by the dashed version of the lifeline stop 302, the lifeline stop 302 may be configured break away or otherwise detach from the housing of the fall limiting device 202 based on forces experienced during the second, fall condition. In such embodiments, the force applied by the reserve retainer 214 to the lifeline stop 302 during a fall event may surpass a maximum holding force between the lifeline stop 302 and the housing of the fall limiting device 202, such that the lifeline stop 302 becomes disconnected from the fall limiting device 202. In embodiments, the connection (e.g., a mechanical connection, an adhesive connection) between the lifeline stop 302 and the fall limiting device 202 is designed to be broken by an expected force experienced during the second, fall condition. The breaking away of the lifeline stop 302 from the fall limiting device 202 allows the retained portion of the lifeline 210 (e.g., lifeline 210 behind the reserve retainer 214) to be paid out from the housing of the fall limiting device 202. In embodiments, a dislodged, broken, or missing lifeline stop 302 provides an indication that a fall has occurred. In some instances, certain components (e.g., lifeline 210, the fall arrest mechanism 218, the reserve retainer 214, the lifeline stop 216/302) are to be replaced, fixed, or refurbished following a fall event. The lifeline stop being in position 302 provides an indication that such replacement activities should occur, preventing reuse of the fall limiting device 202 in a compromised state.

As described above and further below, paying out of the retained portion of the lifeline 210 (e.g., at a fast rate) during a fall condition results in the fall arrest mechanism 218 to be engaged (e.g., based on acceleration forces experienced, based on fast turning of the lifeline drum 212 while the retained portion of the lifeline 210 is unwound during the second, fall condition) to provide a braking force on the lifeline 210. Engaging of the fall arrest mechanism 218, in embodiments, before the lifeline 210 is fully paid out from the housing of the fall limiting device 202 can provide improved fall mitigation and injury prevention. In embodiments, the fall limiting device 202 entering the second, fall condition may result in an alarm condition where an audible alarm from the fall limiting device 202 is emitted or a signal is transmitted from an antenna on the fall limiting device 202 (e.g., to a server that tracks operation data (e.g., to monitor safety protocol compliance), alerts authorities of an alarm condition to initiate sending of help). Such an alarm may be initiated based on activation of a switch (e.g., a switch that is triggered when the lifeline stop 302 breaks away from the housing of the fall limiting device 202, a sensor that detects deployment of the fall arrest mechanism 218).

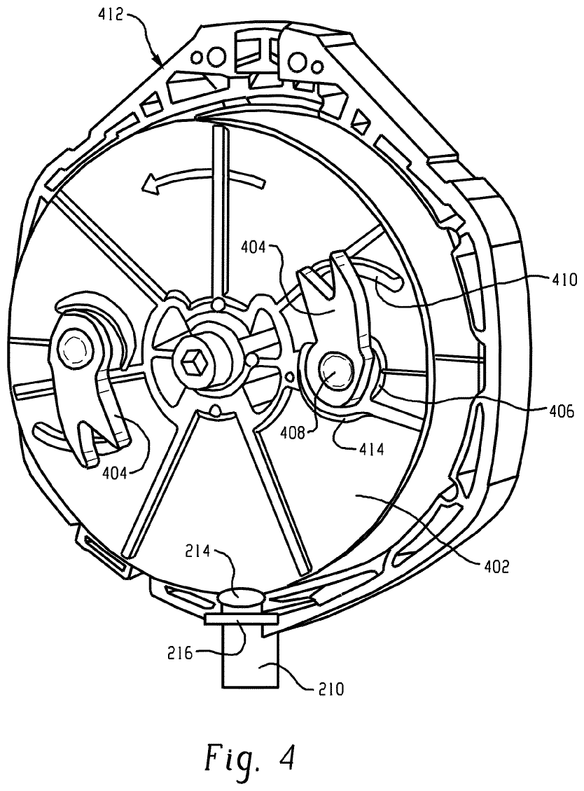

As noted above, a fall arrest mechanism 218 may take a variety of forms. FIG. 4 is a diagram illustrating an unwinding-speed limit control in stowed position attached to a rotatable drum. The outer surface of one of the side portions 402 of the rotatable drum includes structure for retaining the unwinding-speed limit control, which in the example of FIG. 4 includes a spring-biased pawl 404. In the example of FIG. 4, the structure includes a disc-shaped platform 406 on which the pawl 404 sits and a post 408 about which the pawl 404 rotates. In embodiments, the post 408 may be wider at its outward end to aid in retention of the pawl 404, enabling the pawl 404 to be snapped into place. A first, curved guide rail 410 facilitates rotation of the pawl 404 from its stowed position, shown in FIG. 4, to its deployed position via clockwise rotation, where in the deployed position the teeth of the pawl 404 interact with structure of the housing 412 to arrest deployment of the retractable lifeline 210 from the fall limiting device 202. The structure for retaining the pawl 404 further includes a second, curved guide structure 414. That structure 414, in embodiments, may serve multiple purposes. First, that structure 414 may aid in retaining the pawl 404 on the post 408 and may limit counter-clockwise rotation of the pawl 404 to beyond its stowed position. Further, structure 414 may include a structure for interfacing with a spring (not shown). The spring may be positioned between that surface and a surface on the underside of the pawl 404 so as to bias the pawl 404 toward the depicted stowed position when subjected to centripetal force less than the counter-force provided by the spring. Rotation of the drum at faster than a threshold rate (e.g., during the second, fall condition) induces a centripetal force greater than the spring force, which extends the pawls 404 to an engaged position. A reserve retainer 214 is attached to the lifeline 210 so as to retain a sufficient portion of the lifeline 210 in the housing 412 to enable activation of the pawl fall arrest mechanism. During the normal, first operating condition, the reserve retainer 214 hits the lifeline stop 216 preventing full pay out of the lifeline 210. During the second, fall operating condition, the retained portion of the lifeline 210 is allowed to play out, by the reserve retainer 214 breaching the lifeline stop 216, the lifeline stop 216 breaking away from the fall limiting device housing 412, or otherwise. Thus, the fall arrest mechanism will engage any time a fall condition occurs (e.g., when an amount of lifeline less than and up to an amount permitted by the reserve retainer 214 is paid out from the housing 412 prior to the start of a fall condition).

Additional details regarding this fall arrest mechanism may be found in U.S. patent application Ser. No. 17/710,365, filed Mar. 31, 2022, the entirety of which is herein incorporated by reference. Additional examples of fall arrest mechanisms, including those that utilize a tolerance ring as a component in applying a braking force to the lifeline based on motion of the lifeline are provided in U.S. Pat. No. 9,670,980, filed Apr. 18, 2014, the entirety of which is herein incorporated by reference.

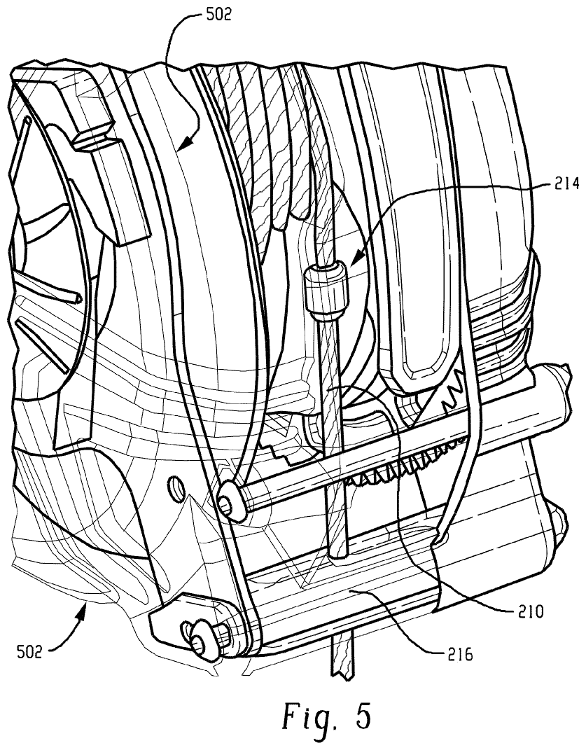

FIG. 5 is a diagram depicting a fall limiting device that utilizes a reserve retainer. The fall limiting device includes a housing 502 having a lifeline therein. Internal to the fall limiting device is a fall arrest mechanism configured to apply a braking force to the lifeline 210 based on a motion of the lifeline 210. The device includes a reserve retainer 214 attached to the lifeline 210. The reserve retainer 214 is configured to retain a portion of the lifeline 210 in the housing 502 during a normal, first operating condition. The fall limiting device further includes a lifeline stop 216 that is configured to assist the reserve retainer 214 with retaining the portion of the lifeline 210 based on interaction between the reserve retainer 214 and the lifeline stop 216 during the first, normal operating condition. In the example of FIG. 5, the lifeline 210 is smaller than an opening in the lifeline stop 216, formed as a slot, such that the lifeline 210 can freely traverse the lifeline stop 216 when being paid out or reeled in. But the reserve retainer 214 is larger than the opening of the lifeline stop 216, such that the reserve retainer 214 cannot traverse the lifeline stop 216 during the first, normal operating condition. The fall limiting device is configured to allow the retained portion of the lifeline 210 to extend from the housing 502 during a second operating condition (e.g., a fall condition), where the fall arrest mechanism is configured to apply the braking force to the lifeline 210 during the second operating condition. Note that in instances where the second, fall condition occurs and the lifeline 210 is not paid out to near the reserve retainer 214, the fall arrest mechanism may apply the braking force and halt pay out of the lifeline 210 before the reserve retainer 214 reaches the lifeline stop 216, such that the retained portion of the lifeline 210 does not extend from the housing 502.

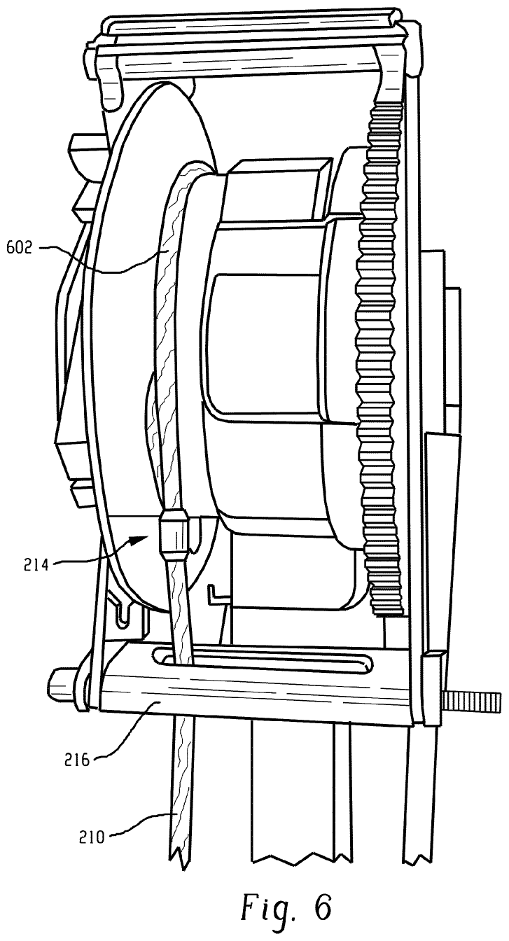

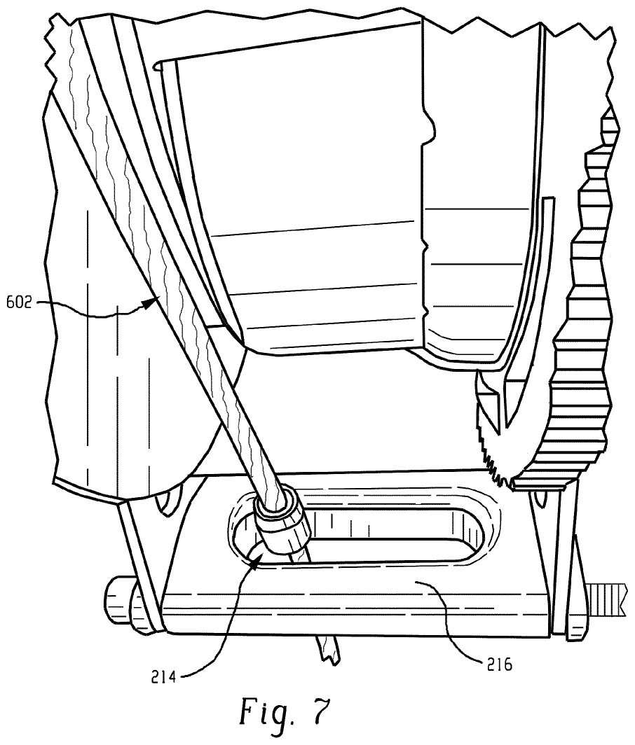

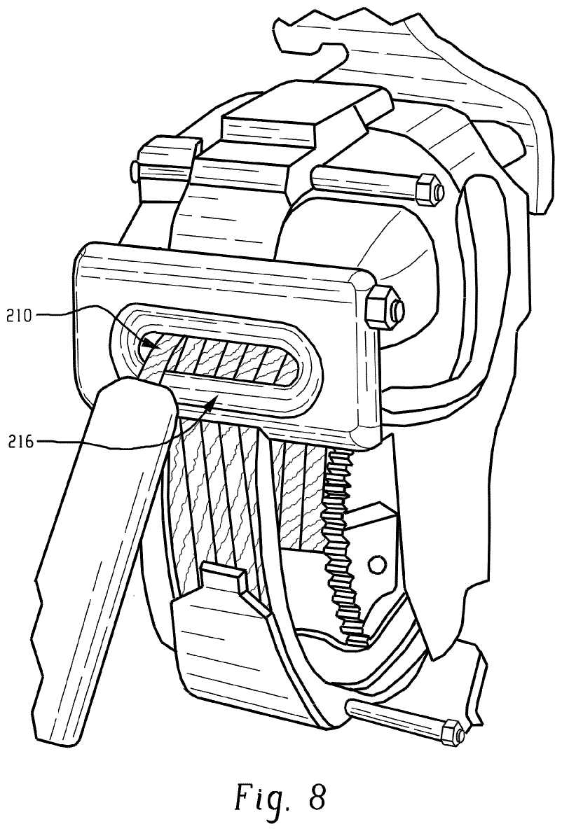

FIG. 6 is an internal view of a fall limiting device. The example of FIG. 6 shows a braided metal lifeline 210 having a reserve retainer 214 attached thereon. A lifeline stop 216 is positioned at an output point of the housing of the fall limiting device, where during a normal operating condition, interaction between the reserve retainer 214, which is wider than the slot of the lifeline stop 216, prevents the retained portion of the lifeline 602 from being paid out from the housing. FIG. 7 provides another internal view of a fall limiting device. FIG. 7 illustrates the reserve retainer 214 interacting with the lifeline stop 216 to retain a portion of the lifeline 602 in the housing during a normal, first operating condition. FIG. 8 provides an exterior view of a fall limiting device in a normal operating condition. FIG. 8 illustrates a lifeline stop 216 in its installed position on an exterior of a housing of the fall limiting device. FIG. 8 shows the lifeline 210 extending from within the housing to the exterior through the lifeline stop 216.

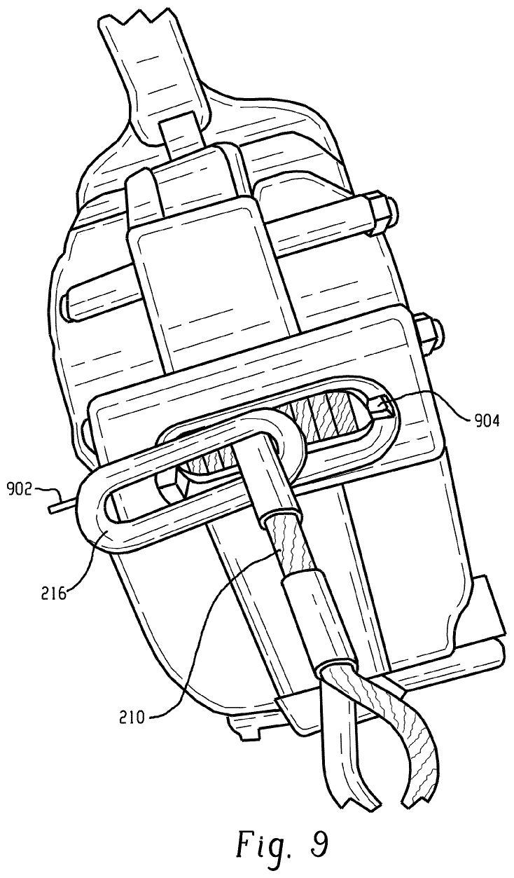

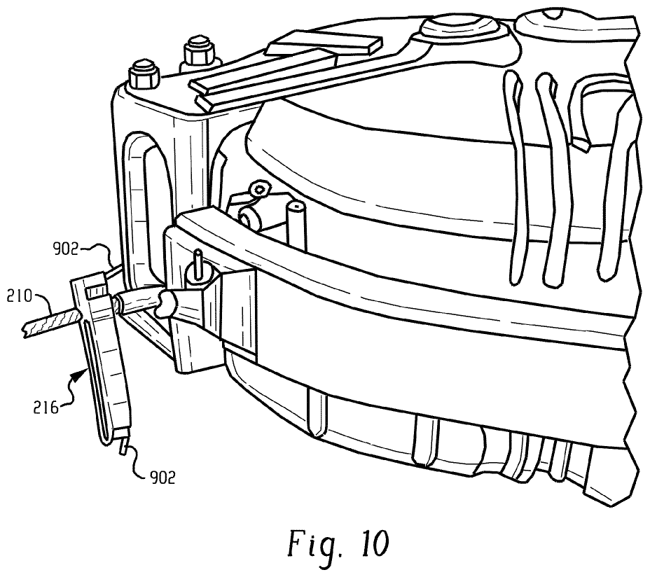

FIG. 9 provides an exterior view of a fall limiting device after experiencing a second, fall operating condition. In FIG. 9, the lifeline 210 extends from the housing through the lifeline stop 216, where the lifeline stop 216 is in a disengaged (disconnected) position. This disengaged position was caused by a force applied to the lifeline stop 216 by a reserve retainer (not shown) when the lifeline 210 experienced a strong force caused by a user falling who was connected to the lifeline 210. The fast-pay-out force dislodged the lifeline stop 216 by overpowering the one or more pins 902 that interact with one or more slots 904 to hold the lifeline stop 216 in place during the normal, first operating condition. The lifeline stop 216 and the components (902, 904) for holding it in place on the fall limiting device housing are designed to retain the lifeline stop 216 in its engaged position (see, FIG. 8) during the normal, first operating condition, and to break away to the disengaged position of FIG. 9 when more than a threshold force likely to occur in a fall scenario is applied to those components 902, 904, 216. For example, the pins 902 may be designed to bend, break, or otherwise deform in the presence of such a force. The dislodged lifeline stop 216 provides an indication that a fall has occurred and that the fall limiting device may require attention (e.g., replacement or refurbishment of certain components). As noted above, a disengaged lifeline stop 216 may result in issuance of an alarm (e.g., based on a switch that is activated when pin 902 is not present in the slot 904. FIG. 10 provides another exterior view of a fall limiting device after experiencing a fall operating condition.

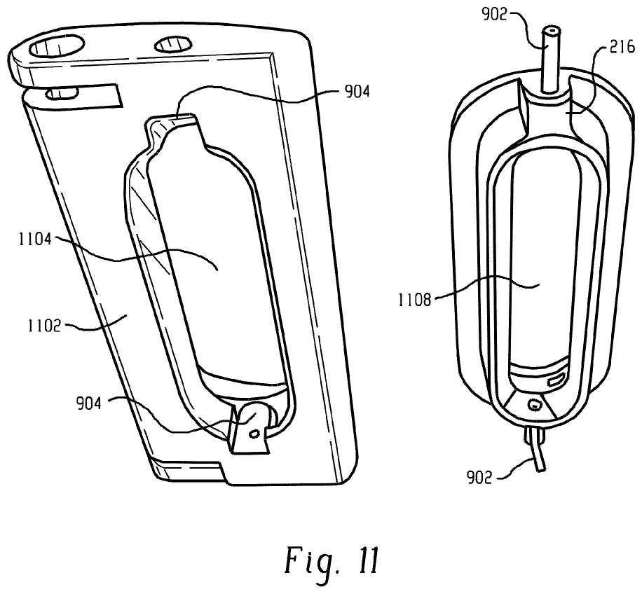

FIG. 11 depicts components of a lifeline stop assembly as shown on the fall limiting device in FIGS. 8 and 9. The lifeline stop assembly includes a frame 1102 having a frame slot 1104 and pin slots 904. The assembly further includes a lifeline stop 216. The lifeline stop 216 has a lifeline slot 1108 that is wide enough for the lifeline to pass through but not wide enough for a reserve retainer to pass through it its normal, intact configuration. The lifeline stop 216 includes pins 902 that are configured to hold the lifeline stop 216 in place in the frame 1102. In one example, the pins 902 provide a designed point of failure, where one or both of the pins 902 are configured to bend or break, dislodging themselves from slots 904 when subjected to fall-condition level forces, thus allowing the retained portion of the lifeline to extend from the housing and enabling the fall arrest mechanism to engage, even when the lifeline is paid out to the maximum allowed by the reserve retainer.

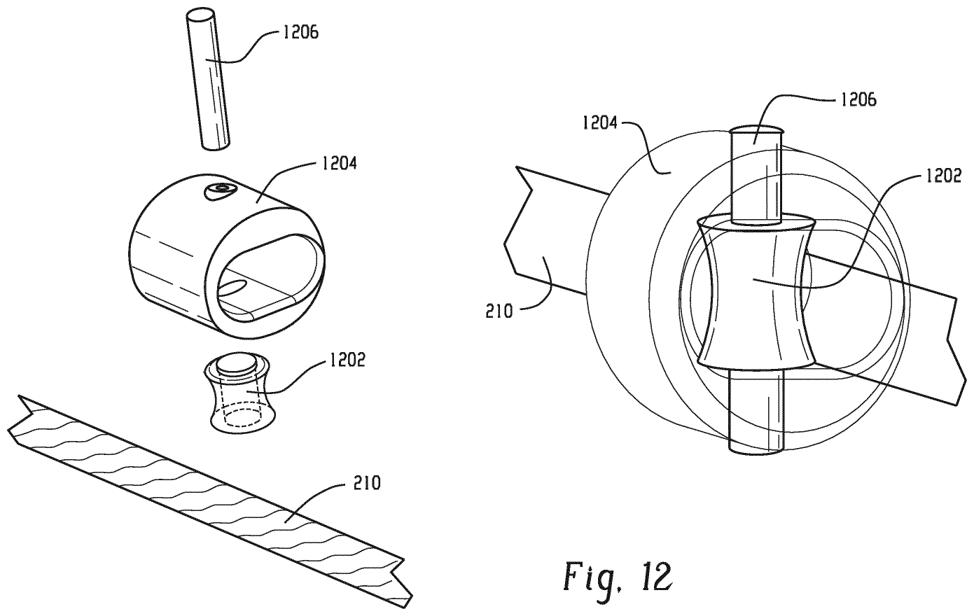

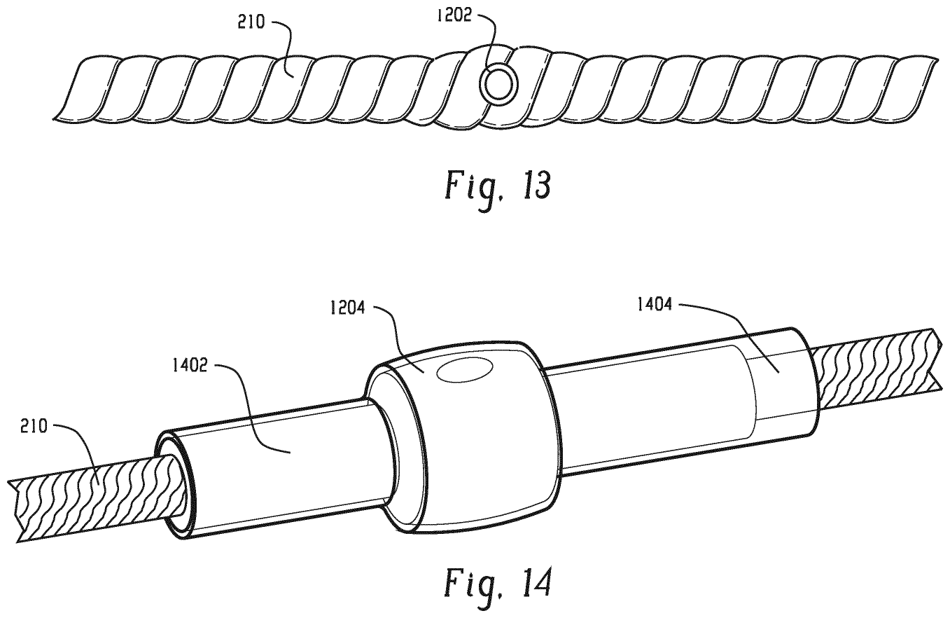

FIG. 12 is a diagram depicting example components of a reserve retainer. The reserve retainer may be attached to the lifeline in a variety of ways, such as mechanical crimping, adhesive, or otherwise. In instances where the lifeline is made of a plurality of strands (e.g., a braided synthetic line, cord, or rope), the reserve retainer can be secured to the line as depicted in FIG. 12 to avoid or mitigate slipping of the reserve retainer along the line. In this example, the strands of the lifeline 210 are parted at the desired installation point to allow a lifeline insert 1202 to be installed within the lifeline 210. The insert 1202 may take a variety of forms, including a pliable material such as deformable rubber some forms of plastic, or a more rigid material such as metal or hard plastic. The lifeline insert 1202 includes a first hole there though. The lifeline 210 having the lifeline insert 1202 installed therein is threaded through a retainer shell 1204. The retainer shell 1204 includes a plurality of second holes. Once in position, a retention pin 1206 (e.g., a tapered pin to induce a stronger fit, a screw) is inserted through one of the second holes of the retainer shell 1204, the first hole of the lifeline insert 1202, and the other one of the second holes of the retainer shell 1204. In embodiments, a heat shrink material (not shown) may then be applied over at least a portion of both the lifeline 210 and the reserve retainer to protect those components from damage. FIG. 13 depicts a braided lifeline 210 having a lifeline insert 1202 inserted between strands of the lifeline 210. FIG. 14 depicts reserve retainer installed on a lifeline, where a first layer of heat shrink 1402 material has been installed with a further second layer of heat shrink material 1404 that covers both the reserve retainer and a portion of the lifeline installed.

FIG. 15 depicts example steps of attaching a reserve retainer to a lifeline. At 1502, a lifeline insert 1202 is inserted between strands of the lifeline, where the lifeline insert 1202 includes a first hole. At 1504, a layer of heat shrink 1402 is added to protect the lifeline (e.g., to prevent the rope from rolling over the lifeline insert 1202 and to protect the lifeline from damage and a portion of the heat shrink 1402, aligned with the first hole of the lifeline insert, is removed. At 1506, the lifeline is inserted into the retainer shell 1204, holes of the retainer shell 1204 being aligned with the hole of the lifeline insert 1202 (and the removed portion of the heat shrink 1402). At 1508, the pin 1206 (e.g., a tapered pin) is installed through both the lifeline insert 1202 and the retainer shell 1204. At 1510, another layer of heat shrink 1404 is added over the reserve retainer and a portion of the lifeline for protection.

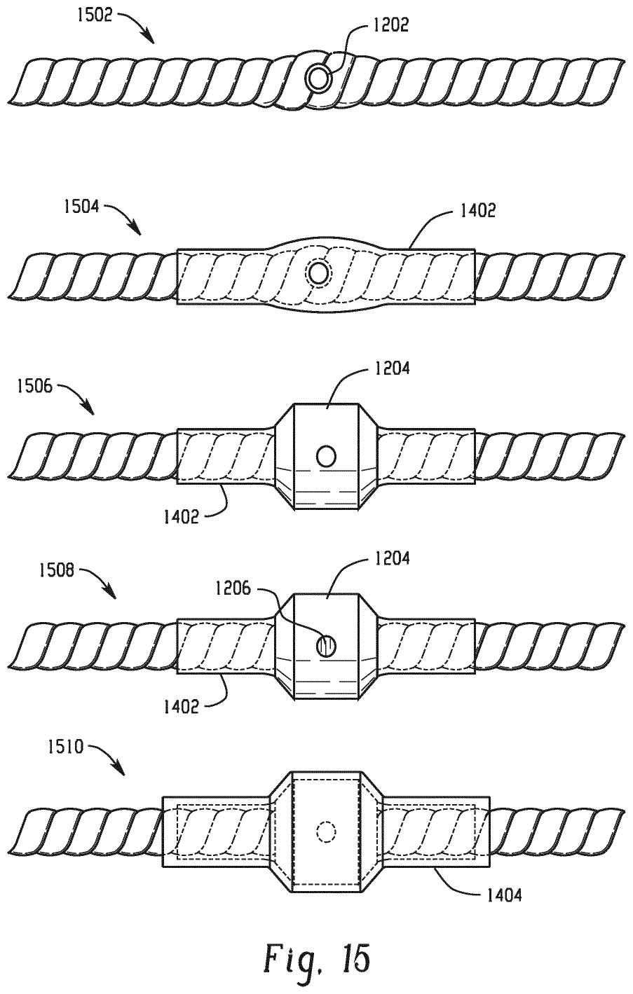

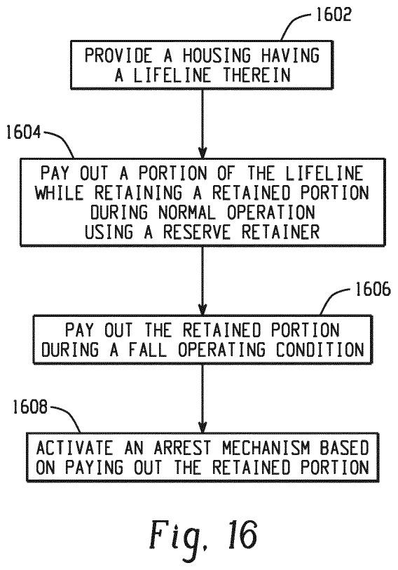

FIG. 16 is a flow diagram depicting a method of arresting a fall of a user includes providing a housing having a lifeline therein at 1602, where the housing is connected to a structure and the lifeline is connected to the user. A portion of the lifeline is paid out from the housing at 1604 while retaining a retained portion of the lifeline in the housing during a normal operating condition, where the retained portion is retained within the housing by a reserve retainer attached to a point on the lifeline. The retained portion is paid out from the housing during a fall operating condition at 1606, and an arrest mechanism is activated at 1608 to apply a braking force to the lifeline based on paying out the retained portion.

While the disclosure has been described in detail and with reference to specific embodiments thereof, it will be apparent to one skilled in the art that various changes and modifications can be made therein without departing from the spirit of the embodiments. Thus, it is intended that the present disclosure cover the modifications and variations of this disclosure provided they come within the scope of the appended claims and their equivalents.

1. A fall limiting device, comprising:
a housing having a lifeline therein;
a fall arrest mechanism configured to apply a braking force to the lifeline based on motion of the lifeline; and
a reserve retainer attached to the lifeline, the reserve retainer being configured to retain a portion of the lifeline in the housing during a first operating condition;
wherein the fall limiting device is configured to allow the retained portion of the lifeline to extend from the housing during a second operating condition, wherein the fall arrest mechanism is configured to apply the braking force to the lifeline during the second operating condition.

2. The device of claim 1, wherein the first operating condition is a non-fall operating condition and wherein the second operating condition is a fall operating condition.

3. The device of claim 1, wherein the lifeline comprises a synthetic material comprising a plurality of strands, wherein the reserve retainer is attached between strands of the lifeline.

4. The device of claim 1, wherein the reserve retainer comprises:
a lifeline insert configured to be inserted between strands of the lifeline, the lifeline insert comprising a first hole;
a retainer shell having a plurality of second holes; and
a retention pin configured to traverse the first hole and the plurality of second holes.

5. The device of claim 1, further comprising heat shrink material covering the reserve retainer in part and the lifeline in part.

6. The device of claim 1, wherein a retention pin is configured to prevent the reserve retainer from sliding along the lifeline.

7. The device of claim 1, wherein the lifeline insert comprises deformable rubber.

8. The device of claim 1, further comprising a lifeline stop, wherein the fall limiting device is configured to retain the portion of the lifeline based on interaction between the reserve retainer and the lifeline stop during the first operating condition.

9. The device of claim 8, wherein the lifeline stop is configured to deform, break, or become dislodged from the housing during the second operating condition.

10. The device of claim 8, wherein the lifeline stop is configured to deform, break, or become dislodged based on a force applied to the lifeline stop by the reserve retainer.

11. The device of claim 8, wherein the deformed, broken, or dislodged lifeline stop provides an indication that a fall has occurred.

12. The device of claim 8, wherein the reserve retainer is configured deform or break based on interaction with the lifeline stop in the second operating condition such that the retained portion of the lifeline is allowed to be extended from the housing.

13. The device of claim 1, wherein the portion of the lifeline is wrapped around a drum within the housing, wherein the fall arrest mechanism is activated to apply the braking force based on rotation of the drum.

14. The device of claim 13, wherein the fall arrest mechanism comprises one or more pawls that are configured to rotate to an extended position based on rotation of the drum above a threshold rate during the second operating condition.

15. The device of claim 1, wherein the fall arrest mechanism comprises a tolerance ring.

16. The device of claim 1, wherein the housing comprises a connection structure for connecting the fall limiting device directly or indirectly to a structure.

17. The device of claim 1, wherein the lifeline comprises a clip or a ring configured for connecting the lifeline to a harness of a user.

18. The device of claim 1, wherein the fall arrest mechanism is configured to apply the braking force any time the second operating condition occurs, regardless of an amount of lifeline paid out from the housing prior to initiation of the second operating condition.

19. The device of claim 1, wherein the fall limiting device is configured to transmit an alarm upon detection of the second operating condition.

20. The device of claim 19, wherein the alarm is a signal that is transmitted wirelessly from the fall limiting device to a computing system.

21. A method of arresting a fall of a user, comprising:
providing a housing having a lifeline therein, wherein the housing is connected to a structure and the lifeline is connected to the user;
paying out a portion of the lifeline from the housing while retaining a retained portion of the lifeline in the housing during a normal operating condition, wherein the retained portion is retained within the housing by a reserve retainer attached to a point on the lifeline;
paying out the retained portion from the housing during a fall operating condition; and
activating an arrest mechanism to apply a braking force to the lifeline based on paying out the retained portion.

22. The method of claim 21, further comprising:
attaching the reserve retainer to the lifeline by:
inserting a lifeline insert between strands of the lifeline, the lifeline insert comprising a first hole;
inserting the lifeline into a retainer shell having a plurality of second holes; and
installing a retention pin that traverses the first hole and the plurality of second holes.

23. The method of claim 21, wherein the retained portion is retained within the housing based on interaction between the reserve retainer and a lifeline stop, wherein the method further comprises:
breaching the lifeline stop or disconnecting the lifeline stop from the housing to allow the retained portion to be paid out from the housing during the fall operating condition.

24. A fall limiting device, comprising:
a housing having a lifeline therein;
a fall arrest mechanism configured to apply a braking force to the lifeline based on motion of the lifeline;
a reserve retainer attached to the lifeline; and
a lifeline stop connected to the housing that is configured to interact with the reserve retainer to retain a portion of the lifeline in the housing during a normal operating condition, wherein the lifeline stop is configured to be breached or disconnected from the housing based on a force greater than a threshold force being applied to the lifeline stop by the reserve retainer.
